(19) United States
(12) Patent Application Publication
(10) Pub. No.: US 2021/0396948 A1
(43) Pub. Date: Dec. 23, 2021

(54) LENS MODULE

(71) Applicant: AAC Optics Solutions Pte. Ltd., Singapore city (SG)

(72) Inventors: Jarno Matikainen, Tampere (FI); Tomi Lintulahti, Tampere (FI)

(21) Appl. No.: 17/008,665

(22) Filed: Sep. 1, 2020

(30) Foreign Application Priority Data
Jun. 23, 2020 (CN) 202021188728.9

(51) Int. Cl. G02B 7/04; H01F 7/02

(52) U.S. Cl. CPC G02B 7/04; H01F 7/02

(57) ABSTRACT

The present disclosure provides a lens module. The lens module includes: a base; a lens carrier movably installed to the base; a driver configured to connect the base with the lens carrier in a transmission way and to drive the lens carrier to partially expand out of or retract into the base; and a magnet assembly provided correspondingly at the base and the lens carrier. The lens carrier can be in press fit with an inner wall of the base under a magnetic force of the magnet assembly, so that the lens carrier can maintain relatively fixed with the base in a direction perpendicular to a telescoping direction during expansion and retraction of the lens carrier. Therefore, the lens carrier and the base can always maintain precise coaxiality in the telescoping direction.

### TECHNICAL FIELD

The present disclosure relates to the technical field of optical lenses, and in particular, to a lens module.

### BACKGROUND

Lenses are common devices in our daily life. For example, for a lens in a camera, especially a zoom camera lens, during an imaging process, it is usually necessary to push and pull the lens for zoom or focus movement of the lens to adjust the distance of the scene or adjust the focal length, so a lens carrier of the lens is usually movably installed to a base of the lens through a driving mechanism.

In order to ensure an imaging effect of the lens, instability factors such as shaking are not allowed when the lens is being focused or zoomed, which requires that the lens carrier and the base shall always have precise coaxiality during use. This also requires that components of the lens shall have a high process accuracy in manufacturing and assembling processes. When there is a gap between the lens carrier and the base, the lens is prone to shake when the lens carrier is expanded or retracted from the base, affecting the imaging effect of the lens.

In summary, the lens in the related art has the problems that the lens requires for high accuracy in manufacturing and assembling, and the lens is prone to shake as the lens carrier is expanded or retracted.

### SUMMARY

In view of this, the present disclosure provides a lens module, to solve the problems in the related art that the lens requires for high accuracy in manufacturing and assembling and the lens is prone to shake as the lens carrier is expanded or retracted.

The lens module provided by the present disclosure includes: a base; a lens carrier movably installed to the base; a driver configured to connect the base with the lens carrier in a transmission way and to drive the lens carrier to partially expand out of or retract into the base; and a magnet assembly provided correspondingly at the base and the lens carrier. The lens carrier is capable of being in press fit with an inner wall of the base under a magnetic force of the magnet assembly.

In an embodiment, the magnet assembly includes: a first magnet provided at the base; and a second magnet provided at the lens carrier and disposed oppositely to the first magnet.

In an embodiment, the first magnet and the second magnet are repulsive to each other; and the lens carrier has a tendency to move away from the first magnet under a repulsive force of the magnet assembly.

In an embodiment, the first magnet and the second magnet are attractable to each other; and the lens carrier has a tendency to move towards the first magnet under an attractive force of the magnet assembly.

In an embodiment, an inner chamfer is formed at a corner of two adjacent inner walls of the base; an outer chamfer is formed at a corner of the lens carrier corresponding to the inner chamfer; and the first magnet is provided in the inner chamfer, and the second magnet is provided in the outer chamfer.

In an embodiment, two magnet assemblies are provided, one of the magnet assemblies are provided correspondingly at opposite wall surfaces of the base and the lens carrier along a first direction, the other one of the two magnet assemblies are provided correspondingly at opposite wall surfaces of the base and the lens carrier along a second direction, and the first direction is perpendicular to the second direction.

In an embodiment, the lens module further includes a bearing roller between mutual press-fit wall surfaces of the base and the lens carrier, and the bearing roller is rollable during expansion and retraction of the lens carrier.

In an embodiment, the inner wall of the base is provided with an installation baffle plate, and an outer wall of the lens carrier is provided with an installation locking slot; and when the lens carrier is installed to the base, the installation baffle plate and the installation locking slot correspondingly define a space in which the bearing roller is to be installed.

In an embodiment, the driver is a SMA drive wire, and the SMA drive wire is stretchable and shrinkable under a regulating current, so as to drive the lens carrier to partially expand out of or retract into the base.

In an embodiment, the base has a corner notch; the lens carrier has a connection corner corresponding to the corner notch; a midpoint of the SMA drive wire is connected and fixed to the connection corner; and two ends of the SMA drive wire are connected obliquely to two corners of the base adjacent to the corner notch, respectively.

In combination with the technical solutions described above, the present disclosure has beneficial effects as follows:

The lens module provided in the present disclosure includes a base, a lens carrier, a driver and a magnet assembly. The lens carrier is movably installed to the base. The driver is configured to connect the base with the lens carrier in a transmission way and can drive the lens carrier to partially expand out of or retract into the base. The magnet assembly is provided correspondingly at the base and the lens carrier. The lens carrier can be in press fit with the inner wall of the base under a magnetic force of the magnet assembly, such that the lens carrier can be relatively fixed with the base in a direction perpendicular to a telescoping direction during expansion and retraction of the lens carrier.

When the lens module is in use, the lens carrier is first installed to the base, and the base is connected to the lens carrier by the driver in a transmission way, and at this time, the lens carrier can be in press fit with the inner wall of the base under the magnetic force of the magnet assembly. In this way, when the driver drives the lens carrier to partially expand out of or retract into the base, the lens carrier and the base can maintain precise coaxiality in the telescoping direction. Even if the outer wall of the lens carrier and the inner wall of the base are relatively worn during use, the lens carrier can always be press fit on the inner wall of the base under the magnetic force of the magnet assembly, thereby avoiding the problem that the lens is prone to shake as the lens carrier is expanded or retracted.

Other features and advantages of the embodiments of the present disclosure will be illustrated in the subsequent description, or partly become apparent from the description, or be understood by implementing the embodiments of the present disclosure. The purpose and other advantages of the embodiments of the present disclosure can be achieved with the structures in the description and the drawings.

### BRIEF DESCRIPTION OF DRAWINGS

FIG. 1 is a schematic diagram of a first structure of a lens module according to an embodiment of the present disclosure;

FIG. 2 is a schematic diagram of a second structure of a lens module according to an embodiment of the present disclosure;

FIG. 3 is a top view of the lens module shown in FIG. 1;

FIG. 4 is a schematic diagram of a third structure of a lens module according to an embodiment of the present disclosure;

FIG. 5 is a schematic diagram of a fourth structure of a lens module according to an embodiment of the present disclosure; and

FIG. 6 is a top view of the lens module shown in FIG. 4.

### REFERENCE NUMERALS

1-base;

11—inner chamfer;

12—installation baffle plate;

13—corner notch;

2—lens carrier;

21—outer chamfer;

22—installation locking slot;

23—connection corner;

3—driver;

4—magnet assembly;

5—bearing roller;

X—first direction;

Y—second direction;

Z—telescoping direction.

The drawings herein are incorporated into and constitute a part of the present specification, illustrate embodiments of the present disclosure and explain principles of the present disclosure together with the specification.

### DESCRIPTION OF EMBODIMENTS

For better illustrating technical solutions of the present disclosure, embodiments of the present disclosure will be described below in details with reference to the accompanying drawings.

It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure are within the protection scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate three cases, i.e., A existing individually, A and B existing simultaneously, B existing individually. In addition, the character “/” herein generally indicates that the related objects before and after the character form an “or” relationship.

It should be understood that, the orientation terms “upper”, “lower”, “left”, “right” and the like are described from the angle shown in the drawing, instead of being construed as limitations to the embodiment of the present disclosure. In addition, when an element is described as being “on” or “under” another element in the context, it should be understood that the element can be directly located “on” or “under” another element or located “on” or “under” another element via an intermediate element.

The specific embodiments of the present disclosure will be described below according to structures of the lens modules provided by the embodiments of the present disclosure.

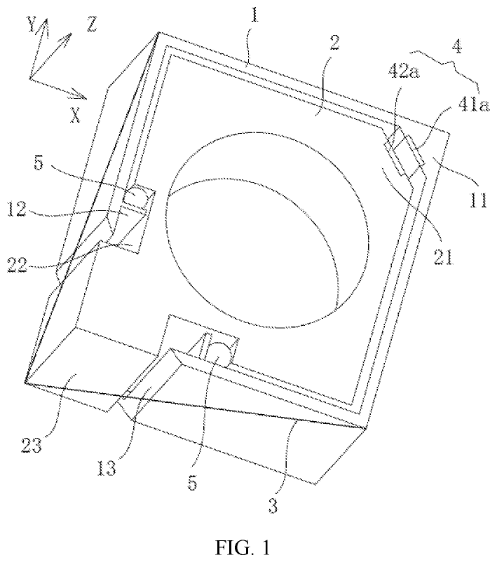

As shown in FIGS. 1-6, an embodiment of the present disclosure provides a lens module including: a base 1, a lens carrier 2, a driver 3 and a magnet assembly 4. The lens carrier 2 is movably installed to the base 1. The driver 3 is configured to connect the base 1 with the lens carrier 2 in a transmission way, and the driver 3 can drive the lens carrier 2 to partially expand out of or retract into the base 1. The magnet assembly 4 is provided correspondingly at the base 1 and the lens carrier 2. The lens carrier 2 can be in press fit with an inner wall of the base 1 under a magnetic force of the magnet assembly 4.

When using the lens module, the lens carrier 2 is first installed to the base 1, the base 1 is connected in a transmission way to the lens carrier 2 by the driver 3, and at this time, the lens carrier 2 can be in press fit with the inner wall of the base 1 under the magnetic force of the magnet assembly 4. In this way, when the driver 3 drives the lens carrier 2 to partially expand out of or retract into the base 1, the lens carrier 2 will not tilt or offset in the XY plane.

This solves the problem in the related art that the lens is prone to shake as the lens carrier is expanded or retracted.

In an optional scheme of this embodiment, the magnet assembly 4 includes a first magnet 41a and a second magnet 42a. The first magnet 41a is provided at the base 1, and the second magnet 42a is provided at the lens carrier 2 and is disposed oppositely to the first magnet 41a.

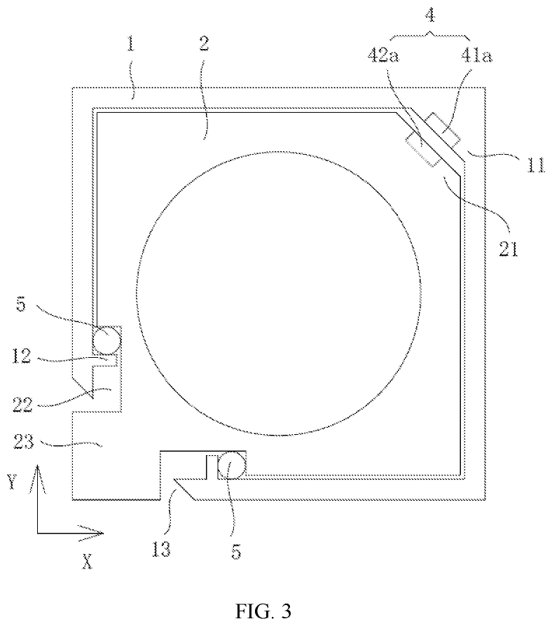

As shown in FIG. 1 or FIG. 3, the magnet assembly 4 includes the first magnet 41a and the second magnet 42a, and the first magnet 41a and the second magnet 42a are provided correspondingly at the inner wall of the base 1 and the outer wall of the lens carrier 2 in the telescoping direction Z, respectively. In this way, when the lens carrier 2 is installed to the base 1, a magnetic force under which the lens carrier 2 is in press fit with the base 2 is generated between the first magnet 41a and the second magnet 42a. When the lens carrier 2 partially expands out of the base 1, a magnetic force is also generated between the first magnet 41 and the second magnet 42.

Both the first magnet 41a and the second magnet 42a may be permanent magnets, such that the magnet assembly 4 can always generate a magnetic force to allow the lens carrier 2 to be in press fit with the inner wall of the base 1. The magnet assembly 4 including the first magnet 41a and the second magnet 42a described above has a simple structure, and the lens carrier 2 can be in press fit with and limited to the base 1 stably.

In addition, in order to enable the lens carrier 2 to be in press fit with and limited to the inner wall of the base 1 in a better way, a plurality of magnet assemblies 4 may be provided correspondingly at the inner wall of the base 1 and the outer wall of the lens carrier 2, respectively.

In an optional scheme of this embodiment, the first magnet 41a and the second magnet 42a are repulsive to each other. The lens carrier 2 has a tendency to move away from the first magnet 41a under a repulsive force of the magnet assembly 4.

As shown in FIG. 1 and FIG. 3, the same magnetic poles of the first magnet 41a and the second magnet 42a are disposed opposite to each other, such that the first magnet 41a and the second magnet 42a are repulsive to each other. In this case, the lens carrier 2 has a tendency to move away from the first magnet 41a under a repulsive force of the magnet assembly 4 to be in press fit with the inner wall of the base 1, such that the lens carrier and the base can maintain precise coaxiality in the telescoping direction Z. Moreover, the inner wall of the base 1 provided with the first magnet 41a and the outer wall of the lens carrier 2 provided with the second magnet 42a are not in direct press-fit contact with each other. In other words, the inner wall of the base 1 provided with the first magnet 41a and the outer wall of the lens carrier 2 provided with the second magnet 42 may be in indirect press-fit contact with each other. Therefore, wear of the magnet assembly 4 caused during expanding or retracting of the lens carrier 2 can be avoided.

In addition, this embodiment further provides another optional scheme for the magnet assembly 4 in this lens module. In this scheme, the first magnet 41b and the second magnet 42b are attractable to each other, and the lens carrier 2 has a tendency to move towards the first magnet 41b under an attractive force of the magnet assembly 4.

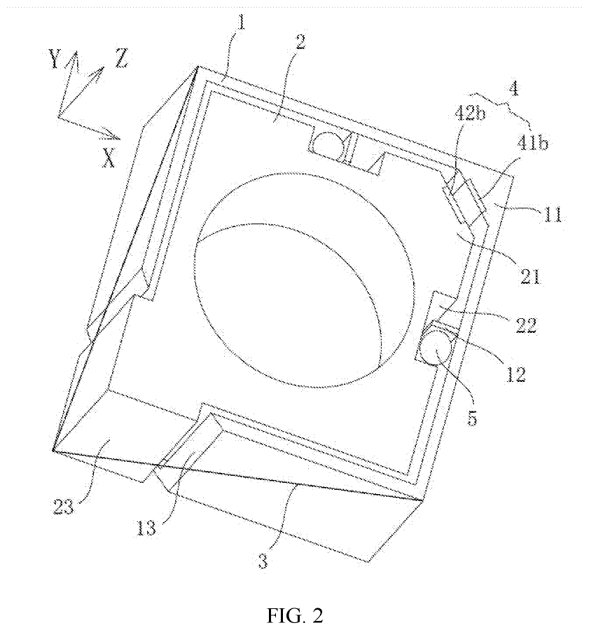

Specifically, as shown in FIG. 2, different magnetic poles of the first magnet 41b and the second magnet 42b are disposed oppositely, such that the first magnet 41b and the second magnet 42b are attractable to each other. In this case, the lens carrier 2 has a tendency to move towards the first magnet 41b under an attractive force of the magnet assembly 4 to be in press fit with the inner wall of the base 1. In this way, it can also enable the lens carrier and the base to maintain precise coaxiality in the telescoping direction Z.

In addition, in order to prevent the first magnet 41b from adsorbing and contacting the second magnet 42b when the lens carrier 2 is in press fit with the inner wall of the base 1, which may make it difficult for the lens carrier 2 to move along the telescoping direction Z, a spacer can be correspondingly provided between the lens carrier 2 and the inner wall of the base 1.

In an optional scheme of this embodiment, an inner chamfer 11 is formed at a corner of two adjacent inner walls of the base 1, and an outer chamfer 21 is formed at a corner of the lens carrier 2 corresponding to the inner chamfer 11. The first magnet 41 is provided at the inner chamfer 11, and the second magnet 42 is provided at the outer chamfer 21.

Specifically, as shown in FIG. 1 and FIG. 3, the inner chamfer 11 is formed at the corner of two adjacent inner walls of the base 1, the outer chamfer 21 is formed at the corner of the lens carrier 2 corresponding to the inner chamfer 11, and the first magnet 41a and the second magnet 42a are provided correspondingly at the inner chamfer 11 and the outer chamfer 21, respectively. In this way, using only one magnet assembly 4, the lens carrier 2 can be press fit and limited to the inner wall of the base 1 in both the first direction X and the second direction Y, thereby fully ensuring installation stability of the lens carrier 2 in the base 1. In this way, the lens carrier 2 and the base 1 can always maintain precise coaxiality in the telescoping direction Z.

An angle of the inner chamfer 11 and an angle of the outer chamfer 21 may be preferably 45°. In this case, a component of the magnetic force generated by the magnet assembly 4 in the first direction X is equal to a component of the magnetic force in the second direction Y.

In an optional scheme of this embodiment, two magnet assemblies 4 are provided. One magnet assembly 4 is provided correspondingly at opposite wall surfaces of the base 1 and the lens carrier 2 along the first direction X; and the other magnet assembly 4 is provided correspondingly at opposite wall surfaces of the base 1 and the lens carrier 2 along the second direction Y. The first direction X is perpendicular to the second direction Y.

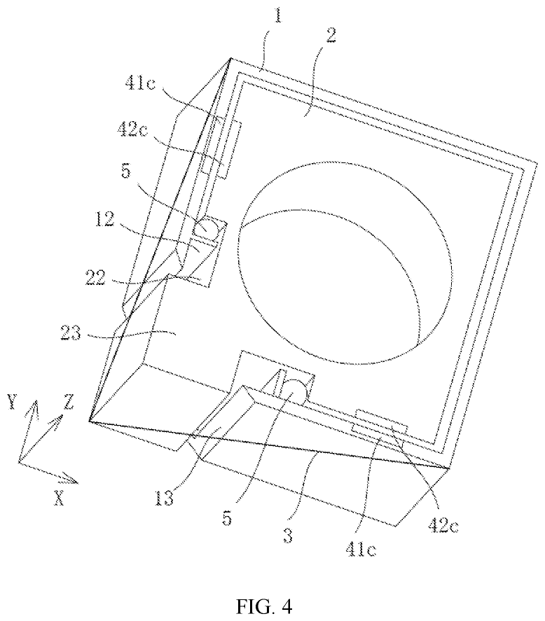

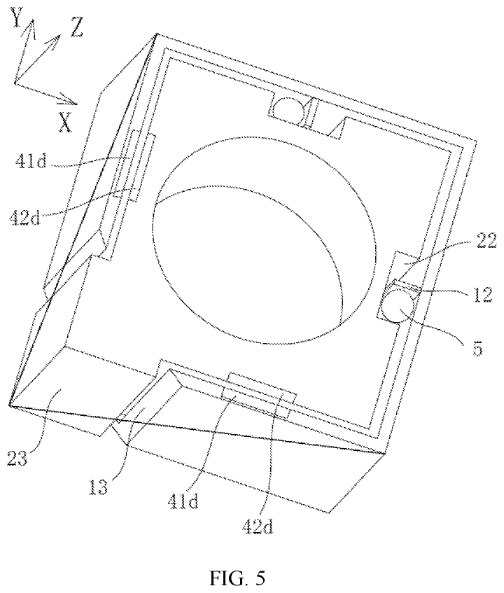

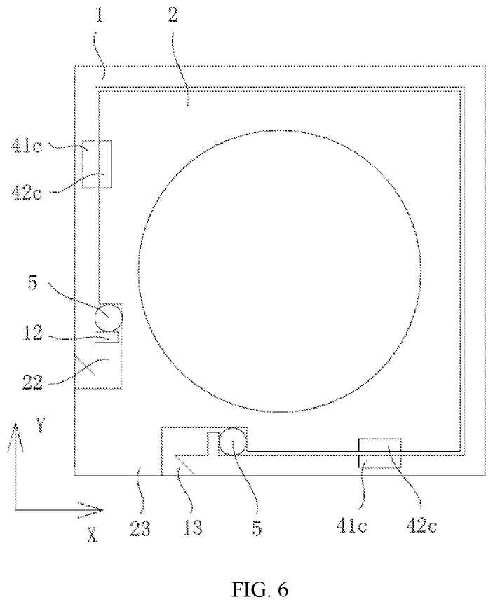

Specifically, as shown in FIG. 4, FIG. 5 and FIG. 6, two magnet assemblies 4 are provided and provided correspondingly at opposite wall surfaces of the base 1 and the lens carrier 2 along the first direction X and opposite wall surfaces of the base 1 and the lens carrier 2 along the second direction Y, respectively. In this case, both of the two magnet assemblies 4 apply magnetic forces between the base 1 and the lens carrier 2 at the same time, such that the lens carrier 2 can be press fit and limited to the inner wall of the base 1 in both the first direction X and the second direction Y. Moreover, effects of the two magnet assemblies 4 do not affect each other. When one of the magnet assemblies 4 fails, the other one of the magnet assemblies 4 can still work normally.

In FIG. 4, each magnet assembly 4 includes a first magnet 41c and a second magnet 42c, the first magnet 41c and the second magnet 42c are attractable to each other. In FIG. 5, each magnet assembly 4 includes a first magnet 41d and a second magnet 42d, the first magnet 41d and the second magnet 42d are repulsive to each other.

In an optional scheme of this embodiment, a bearing roller 5 is further provided between the mutual press-fit wall surfaces of the base 1 and the lens carrier 2. The bearing roller 5 can roll during expansion and retraction of the lens carrier 2.

Specifically, as shown in FIG. 1, the bearing roller 5 may have a spherical shape or a cylindrical shape, and the bearing roller 5 is provided between the mutual press-fit wall surfaces of the base 1 and the lens carrier 2. In this case, the lens carrier 2 is indirectly in press fit with the base 1 through the bearing roller 5. When the lens carrier 2 partially expands out of or retracts into the base 1, the bearing roller 5 will roll, thereby causing rolling friction between the base 1 and the lens carrier 2. In this way, a friction force during expansion and retraction of the lens carrier 2 can be greatly reduced, which is advantageous for the driver 3 to drive an up-and-down movement of the lens carrier 2.

In an optional scheme of this embodiment, the inner wall of the base 1 is provided with an installation baffle plate 12, and the outer wall of the lens carrier 2 is provided with an installation locking slot 22. In this case, when the lens carrier 2 is installed to the base 1, the installation baffle plate 12 and the installation locking slot 22 correspondingly define a space where the bearing roller 5 is to be installed.

Specifically, as shown in FIG. 1, the installation baffle plate 12 may be perpendicular to the inner wall of the base 1, and the installation locking slot 22 may be a rectangular slot. In this case, when the lens carrier 2 is installed to the base 1, the installation baffle plate 12 and the installation locking slot 22 correspondingly define a square space where the bearing roller 5 is to be installed. The bearing roller 5 can form rolling friction with a bottom wall of the installation locking slot 22, a side wall of the installation locking slot 22, a plate surface of the installation baffle plate 12, and the inner wall of the base 1, thereby fully guaranteeing an installation position limitation to the bearing roller 5 in each direction.

In an optional scheme of this embodiment, the driver 3 may be a SMA drive wire. The SMA drive wire can stretch and shrink under a regulating current, so as to drive the lens carrier 2 to expand out of or retract into the base 1.

A characteristic of the SMA (Shape Memory Alloy) material is that, solid phase transition occurs when being heated, which causes the SMA material to shrink. At a low temperature, the SMA material enters a martensite phase; and at a high temperature, the SMA material enters an austenite phase, which causes deformation, thereby causing the SMA material to shrink.

The SMA drive wire made of the SMA material can be controlled to stretch and shrink by regulating a current, such that the lens carrier 2 can be driven to expand out of or retract into the base 1 by regulating a tension force of the SMA drive wire itself, with the advantages such as a simple structure, a small occupied space, and easy operation.

In an optional scheme of this embodiment, the base 1 has a corner notch 13, and the lens carrier 2 has a connection corner 23 corresponding to corner notch 13. A midpoint of the SMA drive wire is connected and fixed to the connection corner 23. Two ends of the SMA drive wire are connected obliquely to two corners of the base 1 adjacent to the corner notch 13, respectively.

Specifically, as shown in FIG. 1, the midpoint of the SMA drive wire is connected and fixed to the connection corner 23, and the two ends of the SMA drive wire are connected obliquely to the two corners of the base 1 adjacent to the corner notch 13, respectively. In this case, the tension force of the SMA drive wire itself includes a component in the first direction X and a component in the second direction Y, which cancel out the magnetic force of the magnet assembly 4. In this way, the lens carrier 2 can be prevented from reversing in a plane of the first direction X and the second direction Y when the SMA drive wire stretches and shrinks. Therefore, the stability of the lens carrier 2 when expanding out of or retracting into the base 1 is further improved.

The above-described embodiments are merely preferred embodiments of the present disclosure and are not intended to limit the present disclosure. Any modifications, equivalent substitutions and improvements made within the principle of the present disclosure shall fall into the protection scope of the present disclosure.

What is claimed is:

1. A lens module, comprising:
a base;
a lens carrier movably installed to the base;
a driver configured to connect the base with the lens carrier in a transmission way and to drive the lens carrier to partially expand out of or retract into the base; and
a magnet assembly provided correspondingly at the base and the lens carrier,
wherein the lens carrier is capable of being in press fit with an inner wall of the base under a magnetic force of the magnet assembly.

2. The lens module as described in claim 1, wherein the magnet assembly comprises:
a first magnet provided at the base; and
a second magnet provided at the lens carrier and disposed oppositely to the first magnet.

3. The lens module as described in claim 2, wherein the first magnet and the second magnet are repulsive to each other; and the lens carrier has a tendency to move away from the first magnet under a repulsive force of the magnet assembly.

4. The lens module as described in claim 2, wherein the first magnet and the second magnet are attractable to each other; and the lens carrier has a tendency to move towards the first magnet under an attractive force of the magnet assembly.

5. The lens module as described in claim 3, wherein an inner chamfer is formed at a corner of two adjacent inner walls of the base; an outer chamfer is formed at a corner of the lens carrier corresponding to the inner chamfer; and the first magnet is provided in the inner chamfer, and the second magnet is provided in the outer chamfer.

6. The lens module as described in claim 4, wherein an inner chamfer is formed at a corner of two adjacent inner walls of the base; an outer chamfer is formed at a corner of the lens carrier corresponding to the inner chamfer; and the first magnet is provided in the inner chamfer, and the second magnet is provided in the outer chamfer.

7. The lens module as described in claim 3, wherein two magnet assemblies are provided,
wherein one of the two magnet assemblies are provided correspondingly at opposite wall surfaces of the base and the lens carrier along a first direction; and the other one of the two magnet assemblies are provided correspondingly at opposite wall surfaces of the base and the lens carrier along a second direction,
wherein the first direction is perpendicular to the second direction.

8. The lens module as described in claim 4, wherein two magnet assemblies are provided,
wherein one of the two magnet assemblies are provided correspondingly at opposite wall surfaces of the base and the lens carrier along a first direction; and the other one of the two magnet assemblies are provided correspondingly at opposite wall surfaces of the base and the lens carrier along a second direction,
wherein the first direction is perpendicular to the second direction.

9. The lens module as described in claim 1, further comprising a bearing roller between mutual press-fit wall surfaces of the base and the lens carrier, wherein the bearing roller is rollable during expansion and retraction of the lens carrier.

10. The lens module as described in claim 9, wherein the inner wall of the base is provided with an installation baffle plate, and an outer wall of the lens carrier is provided with an installation locking slot;
when the lens carrier is installed to the base, the installation baffle plate and the installation locking slot correspondingly define a space in which the bearing roller is to be installed.

11. The lens module as described in claim 1, wherein the driver is a SMA drive wire,
wherein the SMA drive wire is stretchable and shrinkable under a regulating current, so as to drive the lens carrier to partially expand out of or retract into the base.

12. The lens module as described in claim 11, wherein the base has a corner notch;
the lens carrier has a connection corner corresponding to the corner notch;
a midpoint of the SMA drive wire is connected and fixed to the connection corner; and
two ends of the SMA drive wire are connected obliquely to two corners of the base adjacent to the corner notch, respectively.
